(19) United States
(12) Patent Application Publication
(10) Pub. No.: US 2026/0216642 A1
(43) Pub. Date: Jul. 30, 2026

(54) PROCESS FOR REMOVING NITRIC OXIDE, NITROUS OXIDE AND CARBON MONOXIDE FROM A GAS STREAM

(71) Applicant: BASF SE, Ludwigshafen am Rhein (DE)

(72) Inventors: Andreas WOELFERT, Ludwigshafen am Rhein (DE); Georgios DODEKATOS, Ludwigshafen am Rhein (DE); Gerrit WATERS, Ludwigshafen am Rhein (DE); Yvonne RUND, Ludwigshafen am Rhein (DE); Michael OHMER, Ludwigshafen am Rhein (DE); Petra SCHMITZ-BAEDER, Ludwigshafen am Rhein (DE); Holger FRIEDRICH, Ludwigshafen am Rhein (DE)

(21) Appl. No.: 19/146,241

(22) PCT Filed: Jan. 4, 2024
(86) PCT No.: PCT/EP2024/050151

§ 371 Date: Jul. 8, 2025

(30) Foreign Application Priority Data
Jan. 9, 2023 (EP) 23150689.0

(51) Int. Cl. B01D 53/56; B01D 53/62; B01D 53/75; B01D 53/76; B01D 53/86

(52) U.S. Cl. CPC B01D 53/56; B01D 53/62; B01D 53/75; B01D 53/76; B01D 53/864; B01D 2257/404; B01D 2257/502; B01D 2259/10; B01D 2259/122

(57) ABSTRACT

The invention relates to a process for removing nitric oxides, nitrous oxide and carbon monoxide from a gas stream (1), comprising:
(a) Removing nitric oxides from the gas stream (1) by adding an oxygen comprising gas (3) to the gas stream (1), oxidizing the nitrogen monoxide in the gas stream to form nitrogen dioxide, thereby obtaining a gas stream depleted in nitrogen monoxide and washing the gas stream depleted in nitrogen monoxide with water (7) to obtain a gas stream depleted in nitric oxides (11);
(b) Oxidizing at least a part of the carbon monoxide in the gas stream depleted in nitric oxides (11) to form carbon dioxide, thereby obtaining a gas stream depleted in carbon monoxide (19);
(c) Converting nitrous oxide in the gas stream depleted in carbon monoxide (19) into nitrogen and oxygen, if the gas stream depleted in carbon monoxide (19) is free of carbon monoxide, or, if the gas stream depleted in carbon monoxide (19) still contains carbon monoxide, into nitrogen and oxygen and/or carbon dioxide to obtain a purified off-gas stream (25).

The invention relates to a process for removing nitric oxides, nitrous oxide and carbon monoxide from a gas stream.

Gas streams containing nitric oxides, nitrous oxide and carbon monoxide for example occur as off-gas in nitration processes. As nitric oxides and carbon monoxide are harmful and nitrous oxide is a greenhouse gas, it is necessary to reduce or, preferably, completely remove these gases from the gas stream.

Presently, off-gases of nitration processes for example are treated by thermal oxidation by burning the off-gas with high caloric substances like natural gas, or by catalytic oxidation, particularly for removing carbon monoxide.

For reducing nitrous oxide in the off-gas, several abatement technologies are known. Abatement of nitrous oxide preferably is known from production processes of adipic acid. Usually, nitrous oxide is removed from a gas stream by thermal decomposition or by catalytic decomposition. Usually, catalytic decomposition is carried out at a temperature in a range between 300 and 1000° C. in the presence of a suitable nitrous oxide decomposition catalyst, and thermal decomposition is carried out at a temperature above 1000° C. By thermal decomposition and non-reductive catalytic decomposition, the nitrous oxide is decomposed into nitrogen and oxygen. Besides non-reductive catalytic decomposition, it is further possible to reduce the amount of nitrous oxide in a gas stream by reductive catalytic decomposition. For this purpose, the nitrous oxide for example reacts with methane, forming nitrogen, carbon dioxide and water. Non-reductive catalytic decomposition usually is carried out at a temperature in a range between 43° and 1000° C. and reductive catalytic decomposition at a temperature in a range between 30° and 600° C.

Processes for removing nitric oxides and/or nitrous oxide from a gas stream are disclosed for example in DE-A 10 2010 048 040, EP-A 1 022 047, EP-A 0 514 739, WO-A 02/072244, WO-A 03/084646 or WO-A 2013/118064.

According to the processes disclosed in WO-A 02/072244, WO-A 03/084646 or WO-A 2013/118064, a zeolite catalyst is used for the abatement of nitrous oxide.

DE-A 10 2010 048 040 and EP-A 1 022 047 both describe thermal decomposition of nitrous oxide forming oxygen and nitrogen. To remove nitric oxides from the gas stream which may be generated in the process according to DE-A 10 2010 048 040, a reduction agent may be added to the process to selectively reduce the nitric oxides.

EP-A 0 514 739 describes a process for removing nitric oxides from a gas stream obtained by combustion. For creating a reductive environment, in a first step steam is added. In a second step oxygen is added to convert all carbon species into carbon dioxide. In a SCR-unit, residual nitric oxides are converted into nitrogen and oxygen.

Processes in which gas streams containing nitrogen oxides occur, are for example nitrations like the production of dinitrotoluene. Such processes are described for example in WO-A 2015/059185, WO-A 2016/005070, WO-A 2016/050759, WO-A 2011/082977 or U.S. Pat. No. 5,963,878.

Particularly WO-A 2016/050759, WO-A 2011/082977 and U.S. Pat. No. 5,963,878 also deal with the treatment of nitric oxides comprising off-gases which are generated during the process. In the processes as described in WO-A 2011/082977 and U.S. Pat. No. 5,963,878, the nitric oxides comprising waste gas is removed from the process and subjected to a process for producing nitric acid by absorbing the nitric oxides in water. According to the process of WO-A 2016/050759, the nitric oxides comprising waste gas is incinerated. WO-A 2016/005070 only mentions that the waste gas may be treated in a washing device and a following thermal waste gas treatment plant or only in a thermal waste gas treatment plant.

WO-A 2022/152608 describes a process for removing nitrous oxide from a gas stream, and U.S. Pat. No. 8,012,446 and US-A 2013/315810 describe processes for removing nitrogen dioxide from a carbon dioxide containing stream.

Processes for oxidation of carbon monoxide to carbon dioxide from a gas stream are disclosed for example in WO-A 2006/098914, WO-A 2014/138397, EP-B 1558367, US-A 2020/0368727, WO-A 2010/077843 or JP-A 2012-126616.

A further process for oxidizing carbon monoxide is described in U.S. Pat. No. 8,323,602. Additionally, nitrogen monoxide which may be contained in the gas stream is oxidized to form nitrogen dioxide and subsequently removed or is reduced into nitrogen and oxygen.

According to the processes disclosed in Wa2006/098914 or US20200368727, a platinum group metal or a mixture of two or more platinum group metals are used for the carbon monoxide oxidation to carbon dioxide. In the described processes, typically the effluent gas of fluid catalytic cracking unit (FCC) is treated to remove NOₓ and CO. Typically, high residual concentration of carbon monoxide is present in the flue gas of the FCC regeneration unit.

EP-B 1558367 describes a carbon monoxide to carbon dioxide combustion promoter for use in FCC containing aluminium oxide, cerium oxide and a noble metal, like platinum and/or rhodium and/or other noble metal components or a mixture thereof.

Typically, the gas mixture of these processes contains reducible nitrogen species, NO and/or carbon monoxide simultaneously where the catalyst is used for NOₓ purification and carbon monoxide oxidation to carbon dioxide.

Further applications for carbon monoxide oxidation to carbon dioxide can be found in exhaust gas treatment for automotive engines, as disclosed in US-A 2020/0368727, U.S. Pat. No. 11,248,505, WO-A 2010/077843, WO-A 2020/188518 or EP-B 832688.

US-A 2020/0368727 describes a four-way conversion catalyst for the treatment of an exhaust gas stream of a gasoline engine. Besides the removal of particulate matter, hydrocarbons and/or NOx also the removal of carbon monoxide through oxidation to carbon dioxide is described. A porous wall flow filter substrate comprising an on-coating which comprises a platinum group metal supported on a refractory metal oxide is used as catalyst.

It is well known in the literature that carbon monoxide oxidation to carbon dioxide can also be conducted without the presence of NOₓ and under typical oxidative conditions as described in Haruta et al., “Low-Temperature Oxidation of CO over Gold supported on TiO₂, Fe₂O₃, and Co₃O₄”, Journal of Catalysis, 1993, vol. 144, pages 177 to 195.

According to the processes disclosed in WO-A 2014/138397 or JP-A 2012-126616 also metal oxide catalyst for oxidation of carbon monoxide to carbon dioxide can be used. Hence, the process is not limited to noble metal elements, in particular platinum group metals.

WO-A 2014/138397 describes a catalyst for oxidizing carbon monoxide and volatile organic compounds (VOCs) among other components. The catalyst comprises CuO and/or MnO supported on ceria and/or zirconia.

It is a disadvantage of all known processes that for removing nitrogen oxides and/or carbon monoxide from the gas stream, a sufficient amount of reducing agents, heating gases or energy must be supplied.

Therefore, it is an object of the present invention to provide a process for removing nitric oxides, nitrous oxide and carbon monoxide from a gas stream with a minimum supply of reducing agents, heating gases or electrical energy.

This object is achieved by a process for removing nitric oxides, nitrous oxide and carbon monoxide from a gas stream, comprising:
(a) Removing nitric oxides from the gas stream by adding an oxygen comprising gas to the gas stream, oxidizing the nitrogen monoxide in the gas stream to form nitrogen dioxide, thereby obtaining a gas stream depleted in nitrogen monoxide and washing the gas stream depleted in nitrogen monoxide with water to obtain a gas stream depleted in nitric oxides;
(b) Oxidizing at least a part of the carbon monoxide in the gas stream depleted in nitric oxides to form carbon dioxide, thereby obtaining a gas stream depleted in carbon monoxide;
(c) Converting nitrous oxide in the gas stream depleted in carbon monoxide into nitrogen and oxygen, if the gas stream depleted in carbon monoxide is free of carbon monoxide, or, if the gas stream depleted in carbon monoxide still contains carbon monoxide, into nitrogen and oxygen and/or carbon dioxide to obtain a purified off-gas stream.

In the context of the present invention, the term “nitric oxides” means nitrogen monoxide and/or nitrogen dioxide, also being termed as “NOₓ”, wherein x is 1 or 2. The term “nitrogen oxides” means nitric oxides and nitrous oxide and, if appropriate, also further oxides of nitrogen like N₂O₃, N₂O₄, N₂O₅ and NO₃.

Step (a) covers also the removal of nitrogen monoxide formed during the washing of the gas stream by absorption of nitrogen dioxide in water and reaction of nitrogen dioxide with water.

Due to the absorption of nitrogen dioxide in water, besides the gas stream depleted in nitric acids, a solution of nitric acid is formed in step (a). The content of the nitric acid in the solution is in the range from 20 to 65 weight-% and preferably in the range from 40 to 60 weight-%.

The gas stream fed into the process for removing nitric oxides, nitrous oxide and carbon monoxide may be obtained in any process in which nitric oxides, nitrous oxide and carbon monoxide are produced. Such processes for example are nitrations like the production of organic nitro compounds, for example the nitration of benzene, toluene, xylene, phenol, benzoic acid, mono or multiple chlorobenzenes, mono or multiple bromobenzenes, imidazole, 5-ethyl-2-methyl-pyridine. The nitration may be carried out as mononitration, dinitration, or trinitration. Preferably, the gas stream emanates from a mononitration or dinitration and particularly from the production of dinitrotoluene.

The gas stream fed into the process for removing nitric oxides, nitrous oxide and carbon monoxide may be treated in advance by washing with acidic water, preferably with a mixture of water and nitric acid or water and sulfuric acid.

The gas stream to be treated for removing nitric oxides, nitrous oxide and carbon monoxide usually contains carbon monoxide and nitrous oxide with a ratio of carbon monoxide to nitrous oxide in a range from 0.25 to 1 to 4 to 1, preferably in a range from 0.33 to 1 to 3 to 1 and particularly in a range from 0.5 to 1 to 2 to 1, each based on the content by volume percent.

For purifying the gas stream, in the first stage (a) nitric oxides are removed from the gas stream by adding an oxygen comprising gas to the gas stream, oxidizing the nitrogen monoxide in the gas stream to form nitrogen dioxide, thereby obtaining a gas stream depleted in nitrogen monoxide and washing the gas stream depleted in nitrogen monoxide with water to obtain the gas stream depleted in nitric oxides.

For removing the nitric oxides from the gas stream, any process known to a skilled person for removing nitric oxides can be used. Preferably, in a first step the nitrogen monoxide reacts with the oxygen of the oxygen comprising gas to form nitrogen dioxide and subsequently subject the thus produced gas stream depleted in nitrogen monoxide to a washing stage in which the nitrogen dioxide in the gas stream is absorbed in a suitable washing liquid, for example water. Preferably, the reaction is carried out without a catalyst and the reaction conditions are such that the carbon monoxide is not oxidized. The reaction of nitrogen monoxide and oxygen generally is carried out at a temperature in a range from 5 to 280° C., more preferred in a range from 8 to 160° C. and particularly in a range from 10 to 50° C. and a pressure in a range from 1 to 12 bar (abs), more preferred in a range from 3 to 10 bar (abs). Due to these reaction conditions, the carbon monoxide does not start to react with oxygen in step (a).

The oxygen comprising gas may be any gas mixture, which comprises oxygen, or pure oxygen. Preferably, the oxygen comprising gas is air or oxygen enriched air. If a gas mixture different from air is used, it is preferred to use a mixture comprising oxygen and inert gases, for example nitrogen or noble gases. However, particularly preferably, the oxygen comprising gas is air.

For absorbing the nitrogen dioxide, the gas stream depleted in nitrogen monoxide preferably is fed into a washing column. If water is used as washing liquid, during washing nitrogen monoxide and nitric acid are formed. The nitrogen monoxide usually oxidizes again and can be absorbed by the washing liquid.

The washing column used for absorbing the nitrogen dioxide may be a tray column or a packed column. Preferably a tray column is used. In the tray column, the trays preferably are cooled, for example by providing cooling coils on the trays. For cooling, a cooling medium, particularly water, flows through the cooling coils. The number of trays in the tray column preferably is in a range from 2 to 50, preferably from 3 to 15. The trays used for absorbing the nitrogen dioxide in the washing liquid may be any trays known to the skilled person. Suitable trays for example are sieve trays, perforated trays, valve trays or bubble trays.

The washing column usually is operated at a pressure in a range from ambient pressure to 10 bar (abs), preferably at a pressure in a range from 3 bar (abs) to 8 bar (abs). The temperature in the washing column preferably is in a range from 5 to 45° C., preferably from 10 to 30° C.

Depending on the process from which the gas stream to be purified originated, the gas stream depleted in nitric oxides obtained in the washing column usually comprises nitrogen, oxygen, carbon dioxide, carbon monoxide, nitric oxides, and nitrous oxide. If for oxidizing the nitrogen monoxide air is used, the gas stream depleted in nitric oxides further may contain airborne noble gases with the main component argon. Further, particularly if the gas stream to be purified originates from a nitration process, for example from the production of dinitrotoluene, the gas stream depleted in nitric oxides further may contain traces sulfur dioxide, and mononitromethane, dinitromethane, and trinitromethane. Further, the gas stream depleted in nitric oxides may contain non-methane-hydrocarbons.

Generally, the oxygen content in the gas stream depleted in nitric oxides is in a range from 3 to 18 volume-%, preferably 10 to 17 volume-%, the carbon monoxide content is in a range from 0.3 to 7 volume-%, preferably between 0.8 to 5 volume-%, the carbon dioxide content is in a range from 2 to 10 volume-%, preferably in a range from 3 to 7 volume-%, the nitrous oxide content is in a range from 0.2 to 4 volume-%, preferably in a range from 0.3 to 2.5 volume-%, the nitrogen content is in a range from 50 to 90 volume-%, preferably in a range from 60 to 80 volume-% and the content in nitric oxides is in a range from 20 to 800 weight-ppm, preferably in a range from 60 to 400 weight-ppm. If air or oxygen enriched air is used as oxygen comprising gas, the amount of argon in the gas stream depleted in nitric oxides usually is in a range from 0.5 to 0.95 volume-%, particularly in a range between 0.7 and 0.94 volume-%.

After removing the nitric oxides from the gas stream, the obtained gas stream depleted in nitric oxides is fed into stage (b) for oxidizing at least a part of the carbon monoxide.

Before feeding the gas stream depleted in nitric oxides into stage (b), it is preferred to preheat the gas stream. Preferably, the gas stream depleted in nitric oxides is preheated by indirect heat exchange with the hot purified off-gas stream, which simultaneously is cooled.

For this purpose, any suitable heat exchanger may be used, for example a tube bundle heat exchanger, U-tube-bundle heat exchanger or a plate heat exchanger. Preferably, a tube bundle heat exchanger is used.

If preheating the gas stream depleted in nitric oxide by heat is exchange with the purified off-gas stream is not sufficient, an additional heater can be used, for example an electric heater or a burner, for example a gas burner. Preferably, the heater used for additional heating is an electric heater. The additional heater further is used during start-up of the process to heat the gas stream depleted in nitric oxide to the temperature at which stage (b) is carried out.

The temperature to which the gas stream depleted in nitric oxide is heated by indirect heat exchange with the hot purified off-gas stream and/or in the additional heater preferably is in a range from 200 to 400° C., more preferred in a range from 220 to 350° C. and particularly in a range from 230 to 345° C.

In a first alternative, in stage (b) the whole carbon monoxide is oxidized from the gas stream depleted in nitric oxides. However, alternatively and preferably, only a part of the carbon monoxide is oxidized in stage (b) so that the gas stream depleted in carbon monoxide still contains carbon monoxide.

Reaction of the whole carbon monoxide in the context of the present invention means that the amount of non-reacted carbon monoxide is less than 2000 volume-ppm, preferred less than 1000 volume-ppm, more preferred less than 400 volume-ppm and particularly below 200 volume-ppm. For this reason, “free of carbon monoxide” means that the amount of carbon monoxide is less than 2000 volume-ppm, preferred less than 1000 volume-ppm, more preferred less than 400 volume-ppm and particularly below 200 volume-ppm.

If only a part of the carbon monoxide reacts, the gas stream depleted in carbon monoxide still containing carbon monoxide preferably contains more than 2000 volume-ppm up to 6 volume-% carbon monoxide, preferred 4000 volume-ppm to 5 volume-% carbon monoxide, more preferred 6000 volume-ppm to 4 volume-% carbon monoxide and particularly 8000 volume-ppm to 3 volume-% carbon monoxide.

For oxidizing the carbon monoxide to carbon dioxide, any process known to a skilled person can be used. Independent of the process used for oxidizing the carbon monoxide, traces of the carbon monoxide may react with nitrogen oxides. Further, if the oxidization of the carbon monoxide is carried out at temperatures above 350° C. a non-intended reaction of traces of carbon monoxide with nitrous oxide may take place.

For oxidizing only a part of the carbon monoxide contained in the gas stream depleted in nitric oxides, it is possible to select the oxidation conditions, e.g. the oxidation temperature or the GHSV, and/or the catalyst volume such that only a part of the carbon monoxide is oxidized. As an alternative, the gas stream depleted in nitric oxides is split into a first partial stream and a second partial stream and the carbon monoxide in the first partial stream is oxidized in (b) to obtain a partial stream depleted in carbon monoxide.

Independently of whether the whole carbon monoxide or only a part of the carbon monoxide is oxidized in stage (b), the oxidation usually is carried out in a reactor in the presence of a catalyst. The reactor for example may be a vessel with a catalyst bed or a monolithic molded body containing the catalyst. Preferably, a reactor is used which contains at least one monolithic molded body. The monolithic shaped body preferably is designed as a straight prism with a round base or a 4 or 6 sided base, e.g. cylinders or cuboids. The monolithic molded body may be made of the catalytic active material or may be made of a ceramic or metal body which is coated with the catalytic active material.

The monolithic shaped body containing the catalytic active material may be mounted in direct contact into the vessel forming the reactor or may be incorporated into a supporting framework.

In the context of the present invention, the term “catalyst bed” is used for fluidized beds or packed beds. In a catalyst bed, particles or packings of any shape can be used. The particles or packings may either be made of the catalytic active material or may be made of a support material, for example a polymer or a metal, which onto which the catalytic active material is applied.

The catalyst used in the reactor for oxidizing the carbon monoxide preferably is a 3-way catalyst as used for the treatment of exhaust gases for simultaneous destruction of carbon monoxide, hydrocarbons and nitrogen oxides from engine combustion. In this case, residual traces of nitric oxides, which still may be obtained in the gas stream depleted in nitric oxides also are reduced at least partly in stage (b). Alternatively, but less preferred the catalyst may be a 2-way catalyst or a so-called VOC catalyst for the conversion of hydrocarbons and carbon monoxide to carbon dioxide and water by reaction with oxygen. Further catalytic active materials which may be used for the oxidation of the carbon monoxide to from carbon dioxide may be for example mixed oxides like aluminum and/or silicon and/or copper oxides and/or magnesium oxides.

Also suitable as catalytic material for the oxidation of carbon monoxide are precious metals like platinum, ruthenium or palladium. However, these precious metal catalysts usually are sensitive to sulfur. Since the gas stream may contain sulfur-containing components like sulfur dioxide, particularly if the gas stream to be treated originates from a nitration process, the use of mixed oxide catalysts is preferred.

The gas hourly space velocity (GHSV) for the catalyst usually is in a range from 4000 to 200000 standard m³/(m³ catalyst·h), preferably from 8000 to 150000 standard m³/(m³ catalyst·h).

The oxidation of the carbon monoxide to form carbon dioxide in the presence of the catalyst usually takes place at a reaction temperature in a range from 230 to 600° C., preferably in a range from 250 to 540° C. The pressure at which the oxidation of the carbon dioxide is carried out, usually is in a range from 800 mbar (abs) to 10 bar (abs), preferably in a range from 900 mbar (abs) to 8 bar (abs). Particularly preferably, the oxidation of the carbon monoxide is carried out at an excess pressure in a range from 5 to 300 mbar relative to the atmospheric pressure.

If the gas stream depleted in nitric oxides is split into the first partial stream and the second partial stream and the carbon monoxide in the first partial stream is oxidized in (b) to obtain a partial stream depleted in carbon monoxide, after oxidizing the carbon monoxide in the first partial stream, the partial stream depleted in carbon monoxide is mixed with the second partial stream, thereby obtaining a mixed stream depleted in nitric oxides but still containing carbon monoxide.

Mixing of the partial stream depleted in carbon monoxide and the second partial stream may be carried out in any mixing unit for gas streams known to a skilled person. Preferably, the partial stream depleted in carbon monoxide and the second partial stream are combined directly by either introducing the partial stream depleted in carbon monoxide into the second partial stream or by introducing the second partial into the partial stream depleted in carbon monoxide, or by using a static mixer. If the partial stream depleted in carbon monoxide is introduced into the second partial stream or the second partial stream is introduced into the partial stream depleted in carbon monoxide, it is for example possible to use a bypass for the second partial stream bypassing the reactor in which the carbon monoxide of the first stream is oxidized and to open the bypass into a gas line leaving the reactor or open the gas line leaving the reactor into the bypass. As a further alternative, a Y-connector can be used, the bypass being connected to one leg of the Y, the line leaving the reactor being connected to the second leg of the Y and the combined partial streams, forming the gas stream depleted in carbon monoxide, leaves the Y at the base.

If a static mixer is used for mixing the partial stream depleted in carbon monoxide and the second partial stream, any static mixer known to a skilled person may be used. Usually such static mixers comprise inserts which divert the flow, thereby inducing a turbulent flow by which the partial streams are mixed.

Preferably, for mixing the partial stream depleted in carbon monoxide and the second partial stream, a static mixer is used.

The ratio of carbon monoxide to nitrous oxide in the gas stream depleted in carbon monoxide obtained in (b) or, if the gas stream depleted in nitric oxides is split into the first partial stream and the second partial stream, after mixing the partial stream depleted in carbon monoxide and the second stream is in a range from 0.1 to 1 to 2 to 1, preferably 0.3 to 1 to 1.5 to 1.

After oxidizing at least a part of the carbon monoxide, the gas stream depleted in carbon monoxide obtained thereby, or, if the gas stream depleted in nitric oxides is split in partial streams, the mixed stream after remixing the partial streams is fed into stage (c) in which the nitrous oxide is removed from the gas stream depleted in carbon monoxide.

If the whole carbon monoxide is oxidized in stage (b), the nitrous oxide is decomposed into nitrogen and oxygen. If the gas stream depleted in carbon monoxide still contains carbon monoxide, at least a part of the carbon monoxide still contained in the gas stream depleted in carbon monoxide reacts with the nitrous oxide, thereby forming carbon dioxide and nitrogen. Subsequently or simultaneously, the remaining nitrous oxide is converted into nitrogen and oxygen in stage (c).

For decomposing the nitrous oxide into nitrogen and oxygen and/or carbon dioxide, any process known to the skilled person can be used.

Independently of whether the gas stream depleted in carbon monoxide still contains carbon monoxide or whether all carbon monoxide is oxidized in stage (b), usually, the decomposition of the nitrous oxide is carried out in the presence of a suitable catalyst. The catalyst may either be a catalyst bed or a monolithic catalyst, a catalyst bed being preferred. The particles used in the catalyst bed preferably are in the shape of solid cylinders, hollow cylinders or strands. Preferably, the particles used in the catalyst bed are star strands. The strands used in the catalyst bed preferably have an outer diameter of 1.5 to 10 mm, preferably of 2 to 6 mm and a length from 3 to 20 mm, preferably from 4 to 10 mm.

The catalyst may be any commercially available catalyst which can be used for the decomposition of nitrous oxide, for example catalysts comprising copper oxide and/or zinc oxide as catalytic active material on a support made of silicon oxide and/or aluminum oxide. Preferably, the catalyst is a zeolitic catalyst, for example an Fe-beta zeolite of the type ZSM5 or BEA, preferably BEA. Particularly preferably, the catalyst is an organotemplate-free produced catalyst as described in EP-B 2 812 283. Alternatively, a precious metal based catalyst can be used for the decomposition of nitrous oxide, preferably a rhodium based catalyst and more preferably a rhodium based catalyst as described in EP-B 3 227 019.

Further suitable catalysts are for example Fe/Cu-OFF-ERI-zeolites as described for example in CN-A 113198525. The catalyst (Mg_{0.025}Ce_{0.05}Co_{0.925})Co₂O₄—Fe₁-Cu₄—OFF-ERI described in CN-A 113198525 is a composite of three separate compounds and contains about 20 wt % (Mg_{00.025}Ce_{0.05}Co_{0.925})Co₂O₄ spinel, about. 35 wt % of an Fe and Cu exchanged OFF-ERI zeolite and is bound by about 45 wt % AI/Si mixed metal oxide that is presumably also OFF-ERI zeolite.

The decomposition of the nitrous oxide in the presence of the catalyst takes place at a temperature in a range from 300 to 600° C., preferably at a range from 420 to 560° C., and a pressure in a range from 800 mbar (abs) to 10 bar (abs), preferably in a range from 900 mbar (abs) to 8 bar (abs) and particularly in a range from 1000 mbar (abs) to 1200 mbar (abs). Particularly preferably, the decomposition of the nitrous oxide is carried out at an excess pressure in a range from 5 to 300 mbar relative to the atmosphere.

The gas load for decomposing the nitrous oxide may be in a range from 2000 to 30000 standard m³/(m³ catalyst·h), preferably from 4000 to 20000 standard m³/(m³ catalyst·h) and particularly in a range from 8000 to 15000 standard m³/(m³ catalyst·h).

If the gas stream depleted in carbon monoxide still contains carbon monoxide, at least a part of the carbon monoxide reacts with the nitrous oxide, thereby forming carbon dioxide and nitrogen. Depending on the amounts of carbon monoxide and nitrous oxide in the gas stream depleted in carbon monoxide and the reaction conditions, particularly the GHSV, either all of the carbon monoxide comprised in this gas stream reacts with the nitrous oxide or only a part of the carbon monoxide reacts with the nitrous oxide.

If all carbon monoxide contained in the gas stream depleted in carbon monoxide reacts with nitrous oxide, the amount of carbon monoxide usually is such that the nitrous oxide is in excess. For this reason, the remaining nitrous oxide needs to be decomposed forming nitrogen and oxygen.

Both reactions, the conversion of nitrous oxide with carbon monoxide forming carbon dioxide and nitrogen and the decomposing of nitrous oxide forming nitrogen and oxygen usually are carried out in the same reactor at the same conditions. For this reason, if the gas stream depleted in carbon monoxide still contains carbon monoxide, in the reaction in stage (c), a part of the nitrous oxide reacts with the carbon monoxide forming carbon dioxide and nitrogen and simultaneously, nitrous oxide is decomposed into nitrogen and oxygen.

If the amount of carbon monoxide is such that not all of the carbon monoxide reacts with nitrous oxide, the purified gas stream obtained in stage (c) still contains carbon monoxide. To remove the remaining carbon monoxide, the gas stream is subject to a second oxidation of carbon monoxide in which the remaining carbon monoxide is oxidized to carbon dioxide. This second oxidation of carbon monoxide is carried out in the same way as the oxidation of carbon monoxide in stage (b) as described above.

The purified gas stream obtained in (c), if the complete carbon monoxide is oxidized in (b) or if the remaining carbon monoxide has reacted completely with the nitrous oxide, or, after oxidizing the remaining carbon monoxide if the gas stream obtained in (c) still contains carbon monoxide, has usually less than 800 weight-ppm preferably less than 400 weight-ppm nitric oxides, less than 400 weight-ppm preferably less than 200 weight-ppm carbon monoxide and less than 2000, preferably less than 1000 and more preferably less than 500 volume-ppm nitrous oxide and particularly preferably less than 100 volume-ppm nitrous oxide.

Particularly preferably, the process is carried out in such a way that the gas stream depleted in carbon monoxide which is obtained in stage (b) still contains carbon monoxide and that only a part of the remaining carbon monoxide reacts with the nitrous oxide, so that the purified gas stream obtained in stage (c) still contains carbon monoxide and that this remaining carbon monoxide is oxidized in a second oxidation step to form carbon dioxide. For oxidizing the carbon monoxide in the second oxidation step preferably the residual oxygen in the gas stream is used so that no additional oxygen comprising gas needs to be added.

It is a particular advantage of the inventive process that the addition of an external reducing agent can be minimized or completely omitted. It is a further advantage that the process is very effective and environmentally friendly as there are two mechanisms for reducing emissions of carbon monoxide, volatile organic compounds, non-methane hydrocarbons.

It is a further advantage of the inventive process that by separating the conversion of the nitric oxides in step (a) and the oxidization of the carbon monoxide in step (b) into two different steps, the temperature in step (a) is not additionally increased by the reaction heat of the exothermal oxidation of the carbon monoxide because the absorption of the nitrogen dioxide works better at lower temperatures and additional heat generated by the oxidization of carbon monoxide had to be removed. Further, the heat generated in the oxidation of carbon monoxide in step (b) results in a higher temperature of the gas stream depleted in carbon monoxide, which is advantageous for the conversion of nitrous oxide. This additional heating of the gas stream has the advantage, that the amount of catalyst can be kept lower or that the amount of heat to be added can be reduced.

For starting the process, firstly, the catalysts for the oxidation of carbon monoxide and decomposing the nitrous oxide must be brought to operating temperature. This can be achieved by passing a gaseous medium like air, nitrogen or exhaust gas through a heater and then passing the gaseous medium over the catalysts for oxidizing the carbon monoxide and decomposing the nitrous oxide. The gaseous medium used for heating may either be pressurized by a blower so that it flows through the heater and the catalysts, or it can be taken, for example, from the plants operating network. For heating the gaseous medium for example an electric heater may be used. Alternatively, the gaseous medium may be heated by direct or indirect heat exchange with exhaust gases from natural gas combustion or by a regenerative heat exchanger, which is operated with the hot exhaust gas from the catalysts. Preferably, a combination of electric heating and regenerative heating is used. The heating can also take place in several stages simultaneously, e.g. regenerative and electrical heating at the same time.

The heating of the catalysts can be carried out in a straight pass or in a cycle. If the heating is carried out in a cycle, the gaseous medium after having passed the catalysts to be heated is passed again to the input side of the heater by using a suitable blower.

An embodiment of the invention is shown in the FIGURE and described in more detail in the following description.

In the figures:

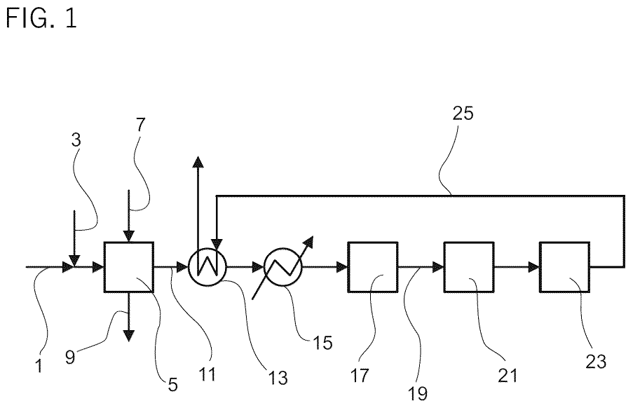

FIG. 1 shows a flowchart of the inventive process.

The only FIGURE shows schematically a flow chart of the inventive process.

For removing nitric oxides, nitrous oxide and carbon monoxide from a gas stream 1, an oxygen comprising gas 3 is added to the gas stream 1. The oxygen of the oxygen comprising gas stream starts to react with the nitrogen monoxide in the gas stream 1, forming nitrogen dioxide. The mixture obtained by adding the oxygen comprising gas stream 3 to the gas stream 1 then is fed into an absorption step 5, in which the gas stream is mixed with water 7, thereby obtaining a nitric acid comprising aqueous stream 9 and a gas stream depleted in nitric oxides 11.

The gas stream depleted in nitric oxides 11 subsequently is preheated in a first heat exchanger 13 and optionally in an additional heater 15. However, preferably, during stationary operation of the process, the additional heater 15 is shut down and the gas stream depleted in nitric oxides 11 only is preheated in the first heat exchanger 13. If, however, the gas stream depleted in nitric oxides 11 is not sufficiently heated in the first heat exchanger 13 or during start-up of the process, the gas stream depleted in nitric oxides 11 is (additionally) heated in the additional heat exchanger 15.

The thus preheated gas stream depleted in nitric oxides then is fed into an oxidation step 17, in which at least a part of the carbon monoxide is oxidized to form carbon dioxide. By this oxidation, a gas stream depleted in carbon monoxide 19 is obtained.

Subsequently, the gas stream depleted in carbon monoxide 19 is fed into a nitrous oxide conversion step 21, in which nitrous oxide is converted into nitrogen and oxygen, if the gas stream depleted in carbon monoxide is free of carbon monoxide, or, if the gas stream depleted in carbon monoxide still contains carbon monoxide, into nitrogen and oxygen and/or carbon dioxide. If in the oxidation step 17 only a part of the carbon monoxide is oxidized, and the gas stream still contains carbon monoxide after the nitrous oxide conversion step 21, the nitrous oxide conversion step 21 is followed by a second oxidation step 23, in which the remaining carbon monoxide is oxidized to carbon dioxide.

By the conversion of nitrogen monoxide to from nitrogen dioxide, the absorption of the nitrogen dioxide in water, the oxidation of carbon monoxide, the conversion of nitrous oxide into nitrogen and oxygen and/or carbon dioxide and the optional second oxidation of carbon monoxide, a purified off-gas stream 25 is obtained.

To operate the process energy-efficient, it is preferred to use the heat of the purified off-gas stream 25 to heat the gas stream depleted in nitric oxides 11 in the first heat exchanger 13. The first heat exchanger may be any heat exchanger, which is suitable for transferring heat from the purified off-gas stream 25 to the gas stream depleted in nitric oxides 11 by indirect heat transfer.

During stationary operation of the process, the heat transferred from the purified off-gas stream 25 to the gas stream depleted in nitric oxides 11 is sufficient for preheating the gas stream depleted in nitric oxides 11 and, therefore, the additional heater 15 can be shut down and the gas stream depleted in nitric oxides 11 only passes the additional heater 15 without being additionally heated. In this case, the additional heater 15 only is necessary for heating the gas stream depleted in nitric oxides 11 during start-up or if the process is operated under partial load and the volume stream of the purified off-gas stream is not sufficient for heating the gas stream depleted in nitric oxides 11.

1.-8. (canceled)

9. A process for removing nitric oxides, nitrous oxide and carbon monoxide from a gas stream, comprising:
(a) removing nitric oxides from the gas stream by adding an oxygen comprising gas to the gas stream, oxidizing the nitrogen monoxide in the gas stream to form nitrogen dioxide, thereby obtaining a gas stream depleted in nitrogen monoxide and washing the gas stream depleted in nitrogen monoxide with water to obtain a gas stream depleted in nitric oxides;
(b) oxidizing at least a part of the carbon monoxide in the gas stream depleted in nitric oxides to form carbon dioxide, thereby obtaining a gas stream depleted in carbon monoxide; and
(c) converting nitrous oxide in the gas stream depleted in carbon monoxide into nitrogen and oxygen, if the gas stream depleted in carbon monoxide is free of carbon monoxide, or, if the gas stream depleted in carbon monoxide still contains carbon monoxide, into nitrogen and oxygen or carbon dioxide to obtain a purified off-gas stream.

10. The process according to claim 9, wherein the oxygen comprising gas is air.

11. The process according to claim 9, wherein the volume ratio of carbon monoxide to nitrous oxide in the gas stream is in a range from 0.25 to 1 to 4 to 1.

12. The process according to claim 9, wherein a part of the carbon monoxide in the gas stream depleted in nitric oxides is oxidized in (b) so that the gas stream depleted in carbon monoxide still contains carbon monoxide and reacting at least a part of the remaining carbon monoxide with the nitrous oxide.

13. The process according to claim 9, wherein to oxidize only a part of the carbon monoxide, the gas stream depleted in nitric oxides is split into a first partial stream and a second partial stream, the carbon monoxide in the first partial stream is oxidized in (b) to obtain a partial stream depleted in carbon monoxide, then mixing the partial stream depleted in carbon monoxide and the second partial stream to obtain a mixed stream, and feeding the mixed stream into (c).

14. The process according to claim 9, wherein a part of the remaining carbon monoxide reacts with the nitrous oxide and, if only a part of the carbon monoxide reacts with the nitrous oxide, oxidizing the remaining carbon monoxide to form carbon dioxide after the decomposition of nitrous oxide in (c).

15. The process according to claim 9, wherein oxidizing the carbon monoxide is carried out at a temperature in a range between 230 to 600° C. and a pressure in a range between 800 mbar (abs) to 10 bar (abs) in the presence of a catalyst.

16. The process according to claim 9, wherein the ratio of carbon monoxide to nitrous oxide in the gas stream depleted in carbon monoxide obtained in (b) or, if the gas stream depleted in nitric oxides is split into the first partial stream and the second partial stream, after mixing the partial stream depleted in carbon monoxide and the second stream is in a range from 0.1 to 1 to 2 to 1.
